(19) United States
(12) Patent Application Publication
(10) Pub. No.: US 2013/0234943 A1
(43) Pub. Date: Sep. 12, 2013

(54) Keyboard Apparatus Having a Backlight Function

(71) Applicant: Qing ZHANG, Changshu (CN)

(72) Inventor: Qing ZHANG, Changshu (CN)

(73) Assignee: Changshu Sunrex Technology Co., Ltd.

(21) Appl. No.: 13/414,583

(22) Filed: Mar. 7, 2012

(51) Int. Cl. G06F 3/02

(52) U.S. Cl. 345/168

(57) ABSTRACT

A keyboard apparatus includes: a keyboard module having a plurality of keys; and a backlight module assembled with the keyboard module. The backlight module includes a light emitter for emitting light, a first light guide plate disposed adjacent to the light emitter and provided with a first reflective member that is aligned with one of the keys in a vertical direction for reflecting the light toward the one of the keys, and a second light guide plate disposed adjacent to the light emitter, provided with a second reflective member that is aligned with another one of the keys in the vertical direction for reflecting the light toward the another one of the keys, and disposed under the first light guide plate.

### BACKGROUND OF THE INVENTION

1. Field of the Invention

This invention relates to a keyboard apparatus having a backlight function, more particular to a keyboard apparatus including first and second light guide plates for guiding light from a light emitter toward different keys, respectively.

2. Description of the Related Art

FIG. 1 illustrates a conventional keyboard apparatus including a keyboard module 11 having a plurality of keys 112, and a backlight module 12 assembled with the keyboard module 11. The backlight module 12 includes a light emitter 121, a light guide plate 122 disposed under the keyboard module 11, and a plurality of reflective elements 123 provided on a bottom surface of the light guide plate 122 for reflecting light toward the keys 112. The light from the light emitter 121 enters a light incident surface 1221 of the light guide plate 122, propagates in the light guide plate 122 along the length of the light guide plate 122, and is reflected by the reflective elements 123 toward the corresponding keys 112, thereby permitting the user to allocate the keys 112 to be operated in a dark environment. Since the light guide plate 122 is well known in the art and is commonly used in the backlight modules for applications, such as displays and illuminating keyboards, further details of the same will not be described herein for the sake of brevity. The aforesaid conventional keyboard apparatus is disadvantageous in that since the keys 112 are spaced apart from the light incident surface 1221 of the light guide plate 122 at different distances, a non-uniform optical visual condition that the light reflected by the reflective element 123 adjacent to the light incident surface 1221 will have a higher intensity than that of the light reflected by the reflective element 123 distal from the light incident surface 1221 occurs. Hence, the characters or symbols on the corresponding keys 112 will not have a uniform brightness and the character or symbol on the key 112 distal from the light incident surface 1221 may not have a sufficient brightness when the light emitter 121 is actuated.

### SUMMARY OF THE INVENTION

Therefore, an object of the present invention is to provide a keyboard apparatus that can overcome the aforesaid drawback associated with the prior art.

According to the present invention, there is provided a keyboard apparatus that comprises a keyboard module having a plurality of keys spaced apart from each other, and a backlight module assembled with the keyboard module and disposed under the keys. The backlight module includes a light emitter for emitting light, a first light guide plate disposed adjacent to the light emitter for guiding the light from the light emitter and provided with a first reflective member that is aligned with one of the keys in a vertical direction for reflecting the light toward said one of the keys, and a second light guide plate disposed adjacent to the light emitter for guiding the light from the light emitter, provided with a second reflective member that is aligned with another one of the keys in the vertical direction for reflecting the light toward said another one of the keys, and disposed under the first light guide plate.

### BRIEF DESCRIPTION OF THE DRAWINGS

In drawings which illustrate an embodiment of the invention,

FIG. 1 is a partly sectional view of a conventional keyboard apparatus; and

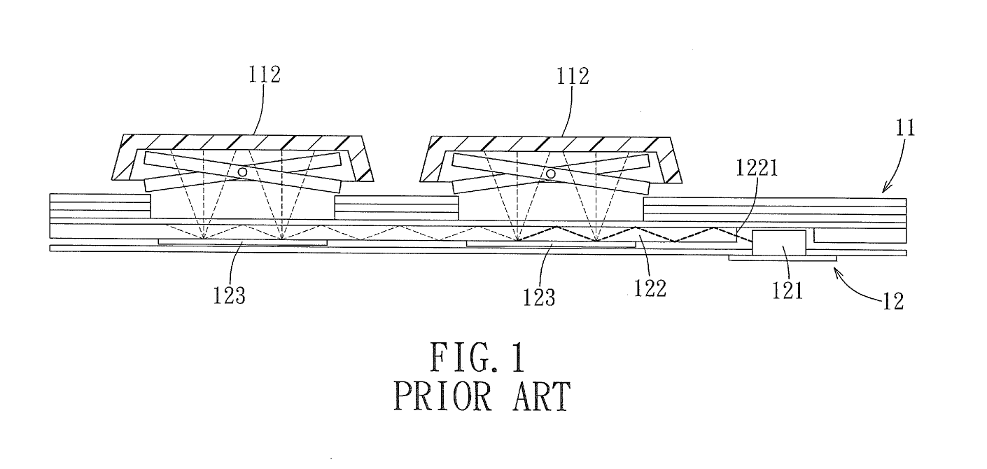

FIG. 2 is a partly sectional view of the preferred embodiment of a keyboard apparatus according to this invention.

### DETAILED DESCRIPTION OF THE PREFERRED EMBODIMENT

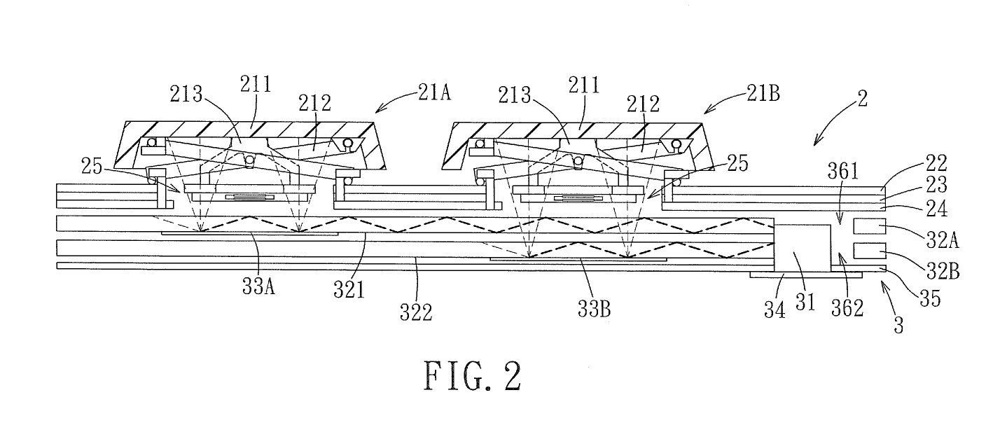

FIG. 2 illustrates the preferred embodiment of a keyboard apparatus according to the present invention. The keyboard apparatus includes: a keyboard module 2 having a plurality of keys 21A, 21B (for the sake of brevity, only two keys 21A, 21B are shown in FIG. 2) spaced apart from each other; and a backlight module 3 assembled with the keyboard module 2 and disposed under the keys 21A, 21B.

The backlight module 3 includes: a flexible circuit board 34 adapted to be connected to a power source (not shown); a light emitter 31 connected to the flexible circuit board 34 for emitting light; a first light guide plate 32A disposed adjacent to the light emitter 31 for guiding the light from the light emitter 31 and provided with a first reflective member 33A that is aligned with one of the keys 21A in a vertical direction for reflecting the light toward said one of the keys 21A; a second light guide plate 32B disposed adjacent to the light emitter 31 for guiding the light from the light emitter 31, provided with a second reflective member 33B that is aligned with another one of the keys 21B in the vertical direction for reflecting the light toward said another one of the keys 21B, and disposed under the first light guide plate 32A; and a reflective plate 35 disposed under 20 the second light guide plate 32B for reflecting the light from the first and second light guide plates 32A, 32B.

The first light guide plate 32A has a bottom surface 321, and has an end portion formed with a first through-hole 361. The first reflective member 33A is made from a reflective ink printed on the bottom surface 321 of the first light guide plate 32A. The second light guide plate 32B has a bottom surface 322, and has an end portion formed with a second through-hole 362. The second reflective member 33B is made from the reflective ink printed on the bottom surface 322 of the second light guide plate 32B. The light emitter 31 extends through the reflective plate 35 and into the first and second through-holes 361, 362 for emitting light in a sidewise direction into the first and second light guide plates 32A, 32B. The first and second light guide plates 32A, 32B overlap and are parallel to each other, are aligned with each other in the vertical direction, and are spaced apart from each other by a gap.

The keyboard module 2 further has a top wall 22 made from a plastic material, a base wall 24 disposed under the top wall 22, and a membrane circuit board 23 sandwiched between the top wall 22 and the base wall 24. The keyboard module 2 is formed with a plurality of key-mounting holes 25 extending through the top wall 22, the base wall 24, and the membrane circuit board 23. The keys 21A, 21B are mounted to the top wall 22, and extend into the key-mounting holes 25, respectively.

Each of the keys 21A, 21B includes a keycap 211, a scissors-shaped frame 212 mounted on the top wall 22 for supporting the keycap 211 thereon, and an urging element 213 urging the scissors-shaped frame 212 for restoring the keycap 211 and the scissors-shaped frame 212 to their original positions. The keycap 211 has a character or a symbol (not shown) formed thereon. The character or the symbol is made from a light transmissive material so as to provide an optical visual effect when the keys 21A, 21B are pressed. Since the design of the keys 21A, 21B, the top wall 22, the base wall 24 and the membrane circuit board 23 is well known in the art, further details of the same will not be described herein for the sake of brevity.

Preferably, the light emitter 31 is a light emitting diode package that has at least one light emitting diode die.

With the inclusion of the first and second light 15 guide plates 32A, 32B and the first and second reflective members 33A, 33B in the keyboard apparatus of this invention, the aforesaid drawback associated with the prior art can be eliminated.

With the invention thus explained, it is apparent that various modifications and variations can be made without departing from the spirit of the present invention.

What is claimed is:

1. A keyboard apparatus having a backlight function, comprising:
a keyboard module having a plurality of keys spaced apart from each other; and
a backlight module assembled with said keyboard module and disposed under said keys, said backlight module including a light emitter for emitting light, a first light guide plate disposed adjacent to said light emitter for guiding the light from said light emitter and provided with a first reflective member that is aligned with one of said keys in a vertical direction for reflecting the light toward said one of said keys, and a second light guide plate disposed adjacent to said light emitter for guiding the light from said light emitter, provided with a second reflective member that is aligned with another one of said keys in the vertical direction for reflecting the light toward said another one of said keys, and disposed under said first light guide plate.

2. The keyboard apparatus of claim 1, wherein said first light guide plate has a bottom surface, said first reflective member being made from a reflective ink printed on said bottom surface of said first light guide plate, said second light guide plate having a bottom surface, said second reflective member being made from said reflective ink printed on said bottom surface of said second light guide plate.

3. The keyboard apparatus of claim 1, wherein said backlight module further includes a reflective plate disposed under said second light guide plate.

4. The keyboard apparatus of claim 1, wherein said keyboard module further has a top wall, a base wall disposed under said top wall, and a membrane circuit board sandwiched between said top wall and said base wall, said keyboard module being formed with a plurality of key-mounting holes extending through said top wall, said base wall, and said membrane circuit board, said keys being mounted into said key-mounting holes, respectively.

5. The keyboard apparatus of claim 4, wherein each of said keys includes a keycap and a scissors-shaped frame mounted on said top wall for supporting said keycap thereon.

6. The keyboard apparatus of claim 5, wherein said top wall is made from a plastic material.

7. The keyboard apparatus of claim 1, wherein said light emitter is a light emitting diode package.

8. The keyboard apparatus of claim 1, wherein said first and second light guide plates overlap each other and are aligned in the vertical direction.
